(19) United States
(12) Patent Application Publication
(10) Pub. No.: US 2016/0104144 A1
(43) Pub. Date: Apr. 14, 2016

(54) SYSTEM AND METHOD FOR DISTRIBUTING DONATIONS

(71) Applicant: Thomas Robbins, Huntingtown, MD (US)

(72) Inventor: Thomas Robbins, Huntingtown, MD (US)

(21) Appl. No.: 14/880,153

(22) Filed: Oct. 9, 2015

Related U.S. Application Data
(60) Provisional application No. 62/061,741, filed on Oct. 9, 2014.

(51) Int. Cl. G06Q 20/22; G06Q 30/02; G06Q 20/40

(52) U.S. Cl. CPC G06Q 20/227; G06Q 20/405; G06Q 30/0279

(57) ABSTRACT

A system is provided for use with a first receiving communication device, a second receiving communication device, a first distribution communication device and a second distribution communication device. The first receiving communication device transmits a first posting signal having a first associated posting value. The second receiving communication device transmits a second posting signal having a second associated posting value. The first distribution communication device transmits a first distribution signal having a first distribution associated value. The second distribution communication device transmits a second distribution signal having a second distribution associated value.

The present application claims priority from: U.S. Provisional Application No. 62/061,741 filed Oct. 9, 2014, the entire disclosure of which is incorporated herein by reference.

### BACKGROUND

The present invention generally deals with crowd funding.

Crowd funding is the practice of funding a project or venture by raising monetary contributions from a large number of people, typically via the internet. Crowdfunding is a form of alternate finance, which has emerged outside of the traditional financial system. The crowdfunding model is based on three types of actors: the project initiator who proposes the idea and/or project to be funded; individuals or groups who support the idea; and a moderating organization (the “platform”) that brings the parties together to launch the idea.

A problem with current crowd funding, systems is that an individual who would like to donate. i.e., a donor, to more than one project in a platform has to provide multiple donations.

Accordingly, for at least the foregoing reasons there exists a need for a system to provide a single donation to multiple projects.

### SUMMARY

The present invention is drawn to a system and method for provide a single donation to multiple projects in a crowd funding platform.

An aspect of the present invention is drawn to system for use with a first receiving communication device, a second receiving communication device, a first distribution communication device and a second distribution communication device. The first receiving communication device transmits a first posting signal having a first associated posting value. The second receiving communication device transmits a second posting signal having a second associated posting value. The first distribution communication device transmits a first distribution signal having a first distribution associated value. The second distribution communication device transmits a second distribution signal having a second distribution associated value.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates a system for distributing donations to requestors in accordance with aspects of the present invention;

FIG. 2 illustrates the system of FIG. 1 at a time t₁, when a first requester posts a request for donations;

FIG. 3 illustrates the system of FIG. 1 at a time t₂, when as second requester posts a request for donations;

FIG. 4 illustrates the system of FIG. 1 at a time t₃, when a first donor submits a donation;

FIG. 5 illustrates the system of FIG. 1 at a time t₄, when a second donor submits a donation;

FIG. 6 illustrates an example of matching device of the system of FIG. 1;

FIG. 7 illustrates an example of database of the matching device of FIG. 6;

FIG. 8 illustrates an example of distributor of the matching device of FIG. 6;

FIG. 9 illustrates a method of distributing donations in accordance with an aspect of the present inventory;

FIG. 10A illustrates an initial state of four posters requesting, donations;

FIG. 10B illustrates the four posters of FIG. 10A with the addition of a proposed single donation;

FIG. 10C illustrates a possible outcome of the proposed single donation of FIG. 10 were split between evenly between the four posters;

FIG. 10D illustrates a first determination of a smallest payment in accordance with aspects of the present invention;

FIG. 10E illustrates equal distribution of the smallest payment to all posters in accordance with aspects of the present invention;

FIG. 10F illustrates a new determination of a new smallest payment in accordance with aspects of the present invention; and

FIG. 10G illustrates a final distribution in accordance with aspects of the present invention.

### DETAILED DESCRIPTION

Aspects of the present invention are drawn to a crowd-funding platform that enables a single donor to post a single donation to a plurality of requestors. For example, if a plurality of cancer researchers post respective individual requests tar donations, a single donor can donate a single donation that can be split between some or all of the plurality of cancer researchers.

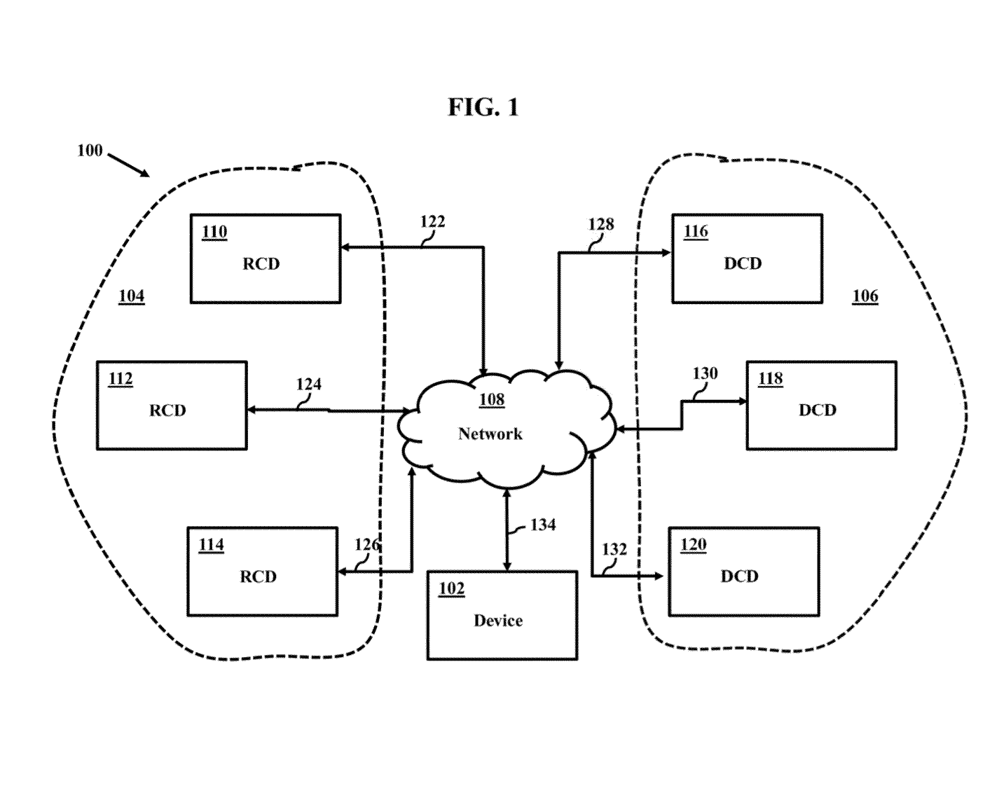

An example system in accordance with aspects of the present invention will now be described with reference to FIGS. 1-10G.

FIG. 1 illustrates a system 100 for distributing donations to requestors in accordance with aspects of the present invention.

As shown in the figure, system 100 includes a matching device 102, a plurality of receiving communication devices 104, a plurality of distribution communication devices 106 and a network 108. Plurality of receiving communication devices 104 may include any number of devices. Yet for purposes of discussion, plurality of receiving communication devices 104 as shown here includes receiving communication device (“RCD”) 110, RCD 112 and RCD 114. Plurality of distribution communication devices 106 may include any number of devices. Yet for purposes of discussion, plurality of distribution communication devices 104 shown here includes distribution communication device (“DCD”) 116, DCD 118 and DCD 120.

RCD 119 is arranged to hi-directionally communicate with network 108 via a communication channel 122. RCD 112 is arranged to hi-directionally communicate with network 108 via a communication channel 124 RCD 114 is arranged to hi-directionally communicate with network 108 via a communication channel 126. DCD 116 is arranged to bi-directionally communicate with network 108 via a communication channel 128. DCD 0118 is arranged to bi-directionally communicate with network 108 via, a communication channel 130. DCD 120 is arranged to hi-directionally communicate with network 108 via a communication channel 132. Matching device 102 is arranged to bi-directionally communicate with network 108 via communication channel 134.

With the above-discussed arrangement, matching device 102 is able to bi-directionally communicate with RCD 110 via communication channel 134, network 108 and communication channel 122; with RCD 112 via communication channel 134, network 108 and communication channel 124; with RCD 114 via communication channel 134, network 108 and communication channel 126; with DCD 116 via communication channel 134, network 108 and communication channel 128; with DCD 118 via communication channel 134, network 108 and communication channel 130; and with DCD 120 via communication channel 134, network 108 and communication channel 132.

An RCD may be any device or system that is operable to transmit a posting signal having an associated posting value. As a non-limiting example, an RCD may be a computer that enables a researcher to send an electronic message to post a request for a donation to support a described research.

A DCD may be any device or system that is operable to transmit a distribution signal having a distribution associated value. As a non-limiting example, a DCD may be a computer that enables a donor to send a message to pledge or transfer funds to a researcher associated with a request for donation provided by an RCD.

Network 108 may be any of known various communication networks, non-limiting examples of which include a Local Area Network (LAN), a Wide Area Network (WAN), a wireless network and combinations thereof. Such networks may support telephony services for a mobile terminal to communicate over a telephony network (e.g., Public Switched Telephone Network (PSTN). Non-limiting example wireless networks include a radio network that supports a number of wireless terminals, which may be fixed or mobile, using various radio access technologies. According to some example embodiments, radio technologies that can be contemplated include: first generation (1G) technologies (e.g., advanced mobile phone system (AMPS), cellular digital packet data (CDPD), etc.), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), 4G, etc. For instance, various mobile communication standards have been introduced, such as first generation (1G) technologies (e.g., advanced mobile phone system (AMPS), cellular digital packet data (CDPD), second generation (2G) technologies (e.g., global system for mobile communications (GSM), interim standard 95 (IS-95), etc.), third generation (3G) technologies (e.g., code division multiple access 2000 (CDMA2000), general packet radio service (GPRS), universal mobile telecommunications system (UMTS), etc.), and beyond 30 technologies (e.g., third generation partnership project (3GPP) long term evolution (3GPP LTE), 3GPP2 universal mobile broadband (3GPP2 UMB), etc.).

Complementing the evolution in mobile communication standards adoption, other radio access technologies have also been developed by various professional bodies, such as the Institute of Electrical and Electronic Engineers (IEEE), for the support of various applications, services, and deployment scenarios. For example, the IEEE 802.11 standard, also known as wireless fidelity (Win), has been introduced for wireless local area networking, while the IEEE 802.16 standard, also known as worldwide interoperability for microwave access (WiMAX) has been introduced for the provision of wireless communications on point-to-point links, as well as for full mobile access over longer distances. Other examples include Bluetooth™, ultra-wide band (UWB), the IEEE 802.22 standard, etc.

Matching device 102 may be any device or system that is operable to match a donation from a DCD to one or more RCDs.

Communication channels 122, 124, 126, 128, 130, 132 and 134 may be any known type of wireless or wired communication channel that is able to transmit information.

An example situation of multiple requestors posting requests for donations and multiple donors providing donations will now be described with additional reference to FIGS.

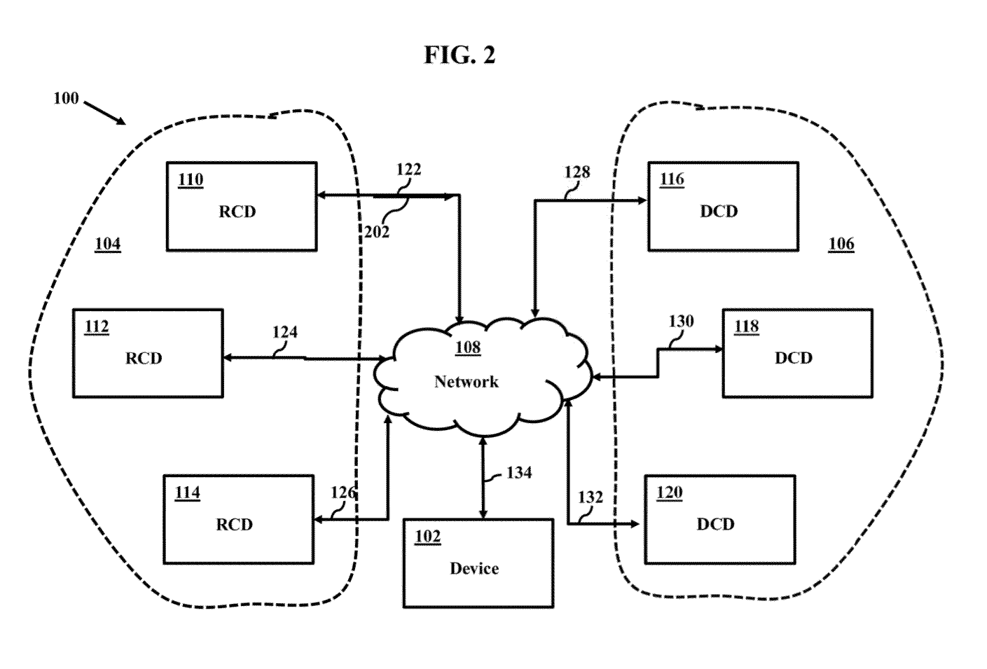

FIG. 2 illustrates system 100 at a time t₁, when a first requester posts a request for donations via RCD 110.

For purposes of discussion, consider the example where a researcher requires $100,000 to purchase laboratory equipment to further cancer research. In such a situation, the researcher may use RCD 110 to send a posting signal 202 to matching device 102. The posting signal may include a description of the researcher's research, a description of the needed equipment and the cost of the equipment. As such, the posting signal will have an associated posting value, which in this example is $100,000.

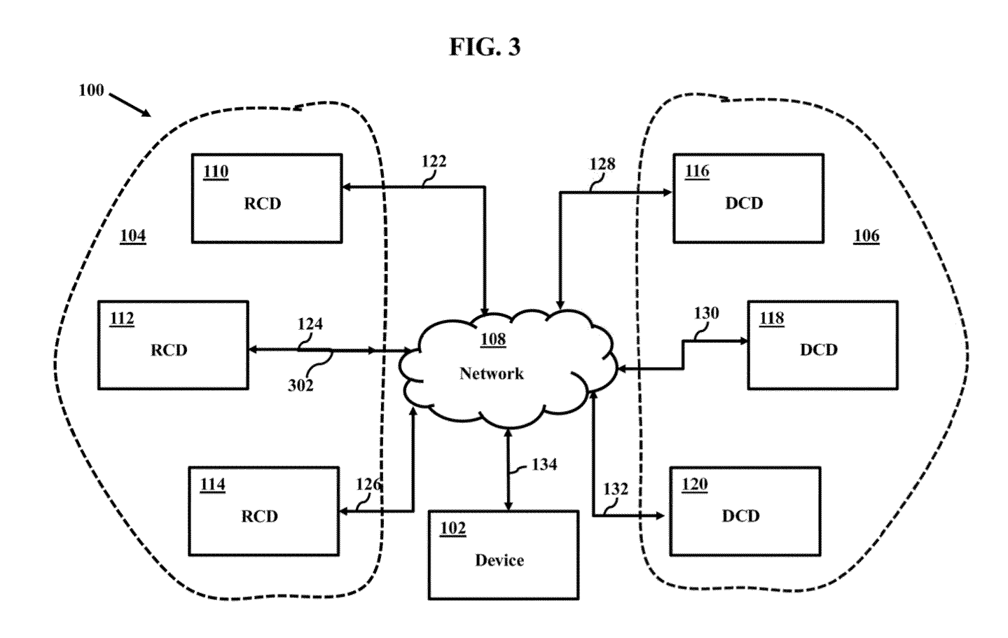

Posting signal 202 is sent via communication channel 122, through network 108 and through communication channel 134 to matching device 102. At some future time, another researcher may send a request for a donation. This will be described with reference to FIG. 3.

FIG. 3 illustrates system 100 at a time t₂, when a second requester posts a request for donations via RCD 112.

For purposes of discussion, now consider the example where a second researcher requires $85,000 to purchase programming services to further cancer research. In such a situation, the researcher may use RCD 112 to send a posting signal 302 to matching device 102. The posting signal may include a description of the researcher's research, a description of the needed services and the cost of the services. As such, the posting signal will have an associated posting value, which in this example is $85,000.

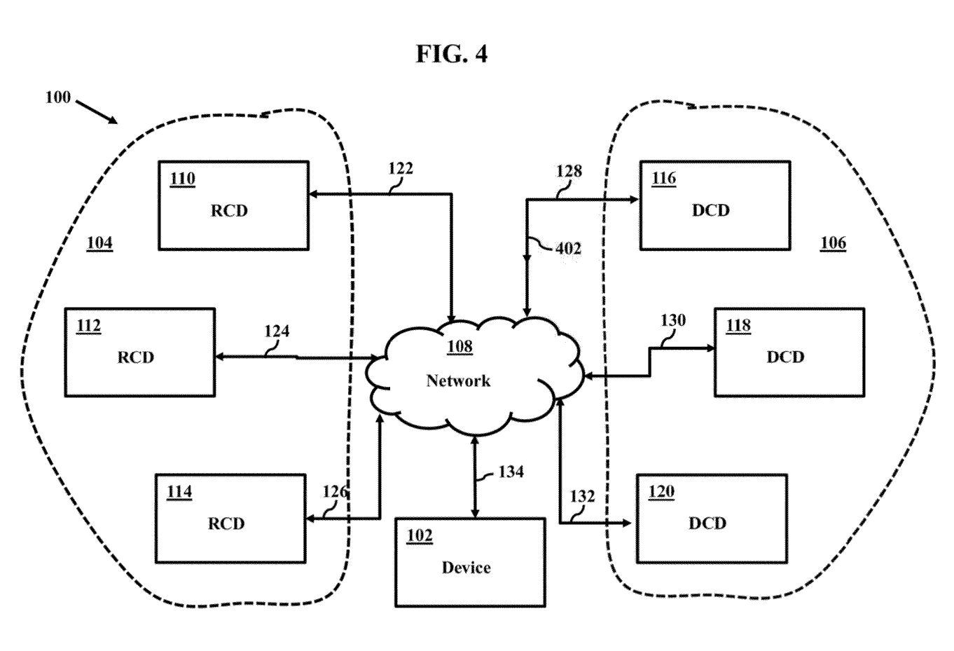

Posting signal 302 is sent via communication channel 124, through network 108 and through communication channel 134 to matching device 102. At some future time, a donor may send a donation. This will be described with reference to FIG. 4.

FIG. 4 illustrates system 100 at a time t₄, when a first donor submits a donation via DCD 116.

For purposes of discussion, consider the example where a donor wants to donate $20,000, but he cannot decide whether to donate to the researcher associated with RCD 110 or the researcher associated with RCD 112. In accordance with aspects of the present invention, the donor may provide a single donation that can be split between both researchers.

In such a situation, the donor may use DCD 116 to send a distribution signal 402 to matching device 102. The distribution signal may include an amount of money to donate or authorization for an amount to donate. As such, the distribution signal will have a distribution associated value, which in this example is $20,000.

Distribution signal 402 is sent via communication channel 128, through network 108 and through communication channel 134 to matching device 102. Matching device 102 then allocated the distribution associated value to the two researchers of RCD 110 and RCD 112. In this manner, the new amount needed by the researcher associated with RCD 110 and the new amount needed by the researcher associated with RCD 112 is less than the original amount.

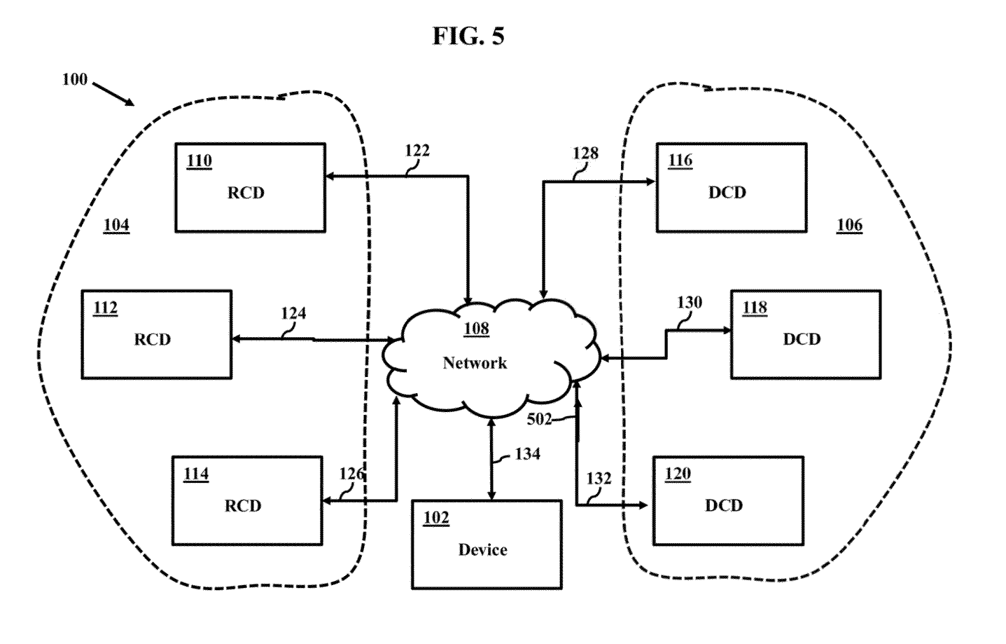

At some future time, another researcher may send a request for a donation. This will be described with reference to FIG. 5.

FIG. 5 illustrates system 100 at a time t₅, when a second donor submits as donation via DCD 120.

For purposes of discussion, now consider the example where a second donor wants to donate $10,000, and he too cannot decide whether to donate to the researcher associated with RCD 110 or the researcher associated with RCD 112. In accordance with aspects of the present invention, the second donor may provide a single donation that can be split between both researchers.

At this point, the second donor may use DCD 120 to send a distribution signal 502 to matching device 102. The distribution signal may include an amount of money to donate or authorization for an amount to donate. As such, the distribution signal will have a distribution associated value, which in this example is $10,000.

Distribution signal 502 is sent via communication channel 132, through network 108 and through communication channel 134 to matching device 192. Matching device 192 then allocated the distribution associated value to the two researchers of RCD 110 and RCD 112. In this manner, the new amount needed by the researcher associated with RCD 110 and the new amount needed by the researcher associated with RCD 112 is less than previous amount after the first donation a $20,000.

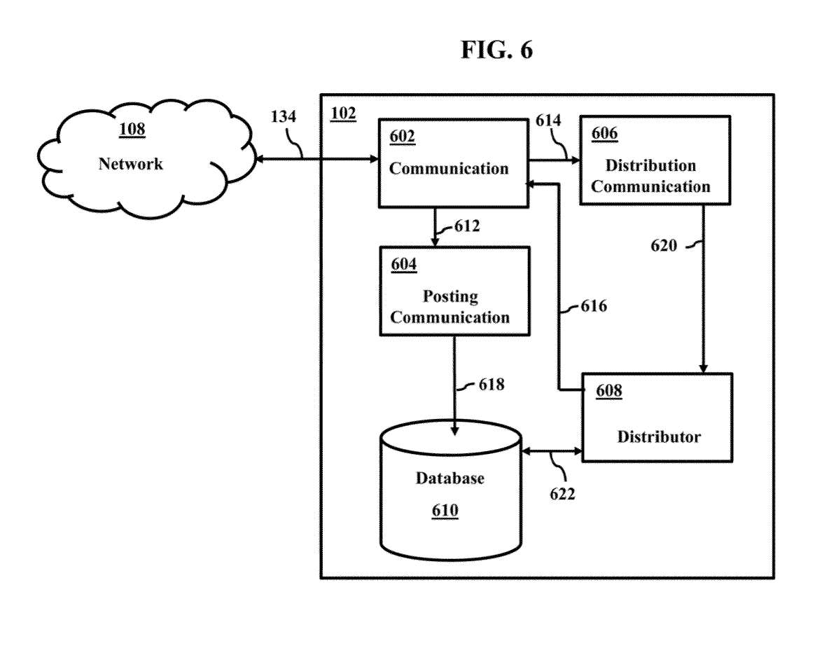

An example system and method for posting requests and matching donations with posted requests will now be described with additional reference to FIGS. 6-8.

FIG. 6 illustrates an example of matching device 102.

As shown in the figure, matching device 102 includes a communication component 602, a posting communication component 604, a distribution communication component 606, a distributor 608 and a database 610.

In this example, communication component 602, posting communication component 604, distribution communication component 606, distributor 608 and database 610 are illustrated as individual devices. However, in some embodiments, at least two of communication component 602, posting communication component 604, distribution communication component 606, distributor 608 and database 610 may be combined as a unitary device. Further, in some embodiments, at least one of communication component 602, posting communication component 604, distribution communication component 606, distributor 608 and database 610 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM. ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Communication component 602 is arranged to communicate with network 108 via communication channel 134, to communicate with posting communication component 604 via a communication channel 612, to communicate with distribution communication component 606 via a communication channel 614 and to communicate with distributor 608 via a communication channel 616.

Posting communication component 604 is additionally arranged to communicate with database 610 via a communication channel 618.

Distribution communication component 606 is additionally arranged to communicate with distributor 608 via a communication channel 620.

Distributor 608 is additionally arranged to communicate with database 610 via a communication channel 622.

Communication component 602 may be any device or system that is operable to receive and send signals by known communication standards.

Posting communication component 604 may be any device or system that is operable to receive the posting signals from communication component 602 and determine the associated posting values.

Distribution communication component 606 may be any device or system that is operable to receive the distribution signals and determine the distribution associated values.

Distributor 608 may be any device or system that is operable to access database 610 and to distribute distribution amounts based on received distribution signals.

Database 610 may be any device or system that is operable to manage, store and retrieve data.

Communication channels 612, 614, 616, 618, 620 and 622 may be any known type of wireless or wired communication channel that is able to transmit information.

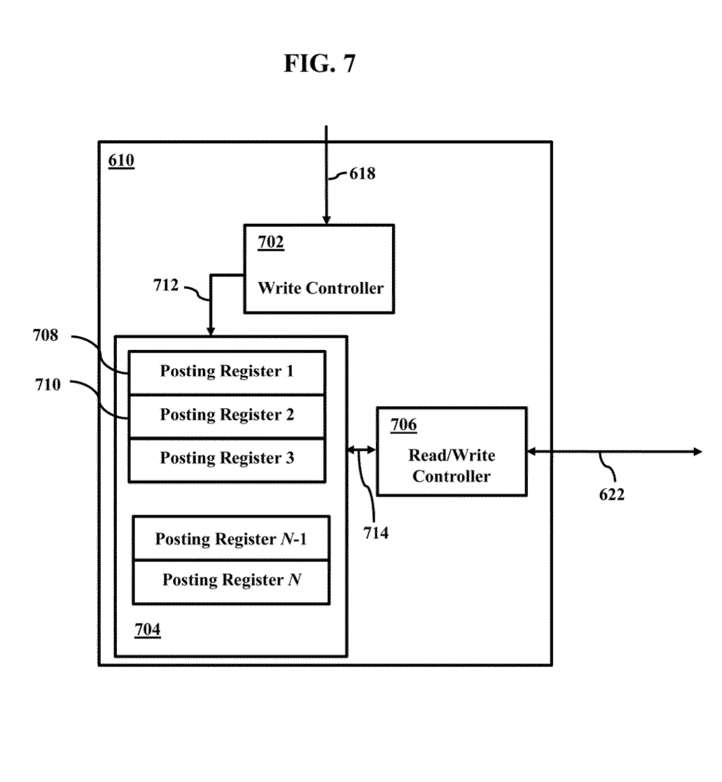

FIG. 7 illustrates an example of database 610.

As shown in the figure, databased 610 includes a write controller 702, a plurality of storage registers 704 and a read/write controller 706. Plurality of storage registers 704 may have a number N of individual storage registers, a sample of which are numbered storage register 708 and storage register 710.

In this example, write controller 702, plurality of storage registers 704 and read/write controller 706 are illustrated as individual devices. However, in some embodiments, at least two of write controller 702, plurality of storage registers 704 and read/write controller 706 may be combined as a unitary device. Further, in some embodiments, at least one of write controller 702, plurality of storage registers 704 and read/write controller 706 may be implemented as a computer having tangible computer-readable media for carrying or having computer-executable instructions or data structures stored thereon.

Write controller 702 is arranged to communicate with posting communication component 604 via communication channel 618 and to communicate with plurality of storage registers 704 via a communication channel 712.

Read/write controller 706 is arranged to communicate with distributor 608 via communication channel 622 and to communicate with plurality of storage registers 704 via a communication channel 714.

Each of plurality of storage registers 704 may be any device or system that is operable to

Write controller 702 may be any device or system that is operable to

Read/write controller 706 may be any device or system that is operable to

Communication channels 612, 614, 616, 618, 620 and 622 may be any known type of wireless or wired communication channel that is able to transmit information.

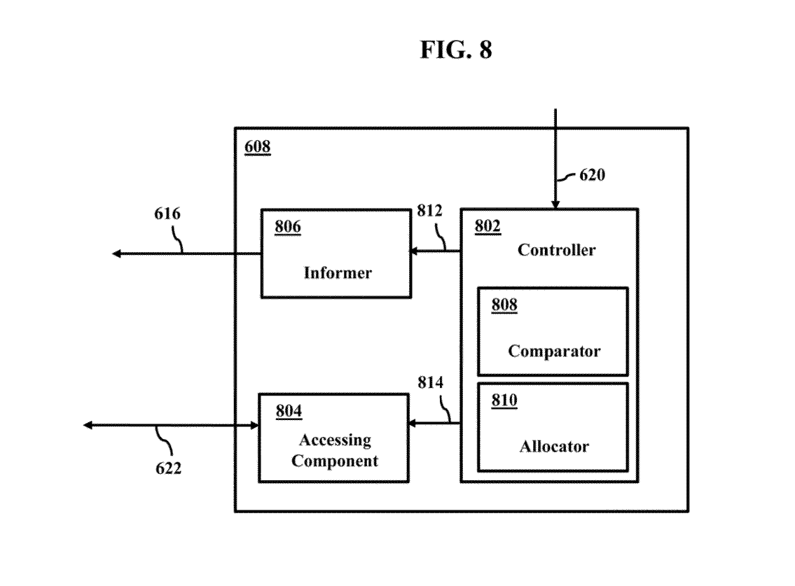

FIG. 8 illustrates an example of distributor 608.

As shown in the figure, distributor 608 includes a controller 802, an accessing component 804 and an informer 806. Controller 802 further includes a comparator 808 and an allocator 810.

In this example, write comparator 808 and allocator 810 are illustrated as individual devices. However, in some embodiments, write comparator 808 and allocator 810 may be combined as a unitary device. Further, in some embodiments, at least one of write comparator 808 and allocator 810 may be implemented as a computer having tangible computer-readable media for carrying or having computer-executable instructions or data structures stored thereon.

Further, in this example, controller 802, accessing component 804 and informer 806 are illustrated as individual devices. However, in some embodiments, at least two of controller 802, accessing component 804 and informer 806 may be combined as a unitary device. Further, in some embodiments, at least one of controller 802, accessing component 804 and informer 806 may be implemented as a computer having tangible computer-readable media for carrying or having computer-executable instructions or data structures stored thereon.

Controller 802 is arranged to communicate with posting communication component 604 via communication channel 620, to communicate with informer 806 via a communication channel 812 and to communicate with accessing component 804 via a communication channel 814.

Informer 806 is additionally arranged to communicate with communication component 602 via communication channel 616.

Accessing component 804 is additionally arranged to communicate with database 610 via communication channel 622.

Controller 802 may be any device or system that is operable to provide information to informer 806 and accessing component 804.

Comparator 808 may be any device or system that is operable to provide an output based on a comparison of a first input and a second input.

Allocator 810 may be any device or system that is operable to allocate different distribution amounts.

Accessing component 804 may be any device or system that is operable to access a database such as database 610.

Informer 806 may be any device or system that is operable to provide an indication for an RDC that indicates an allocated distribution amount.

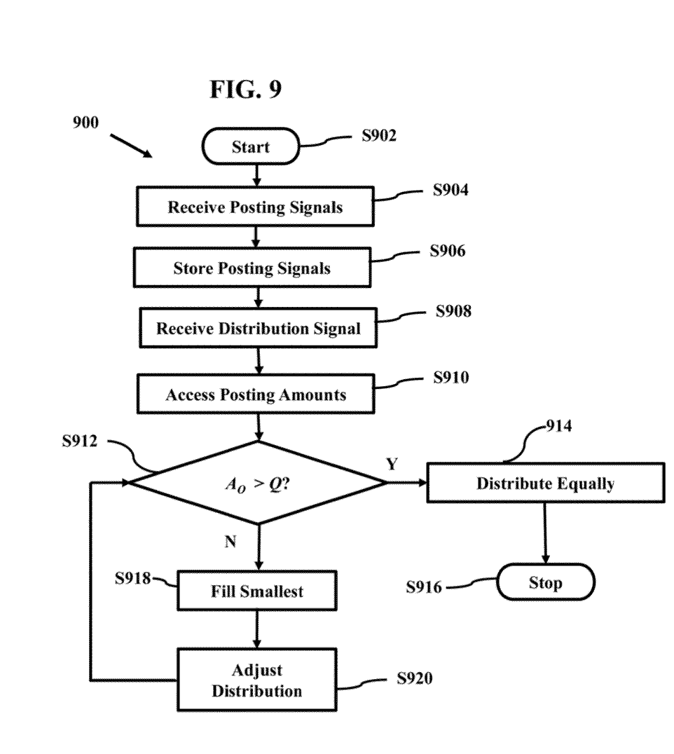

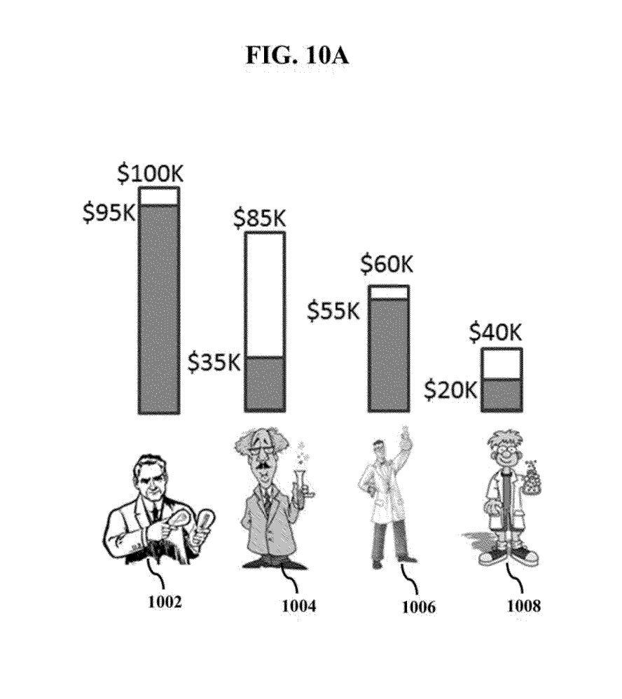

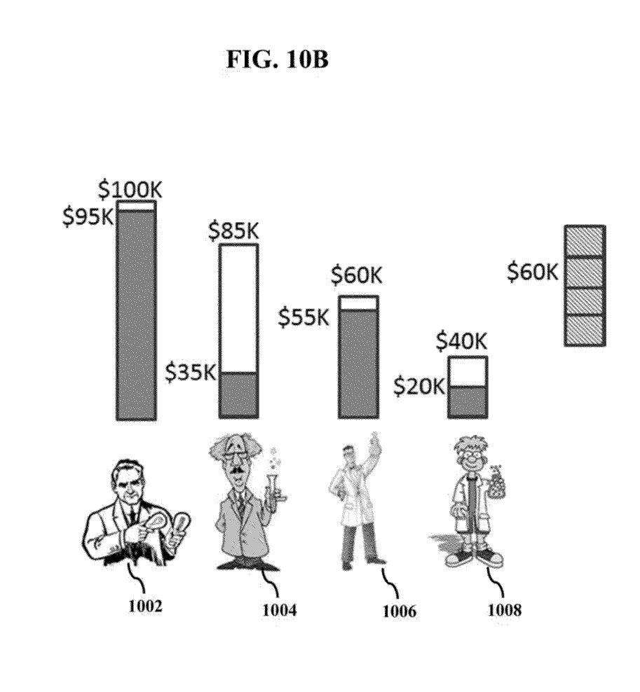

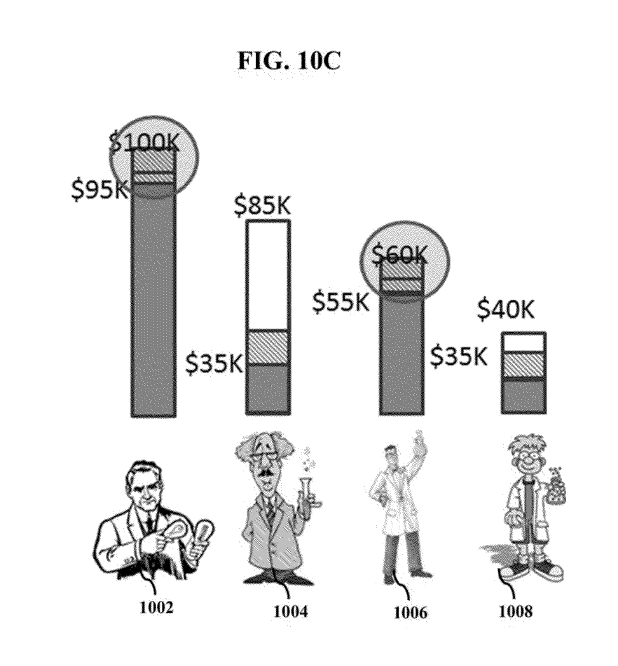

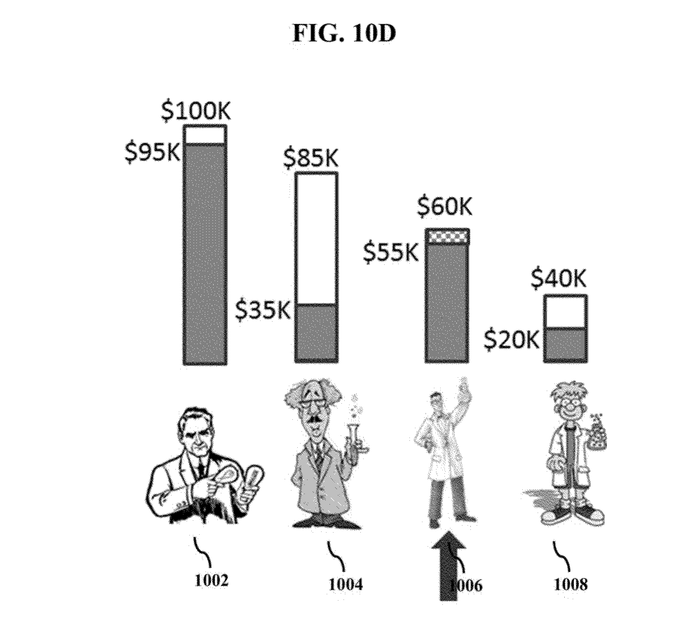

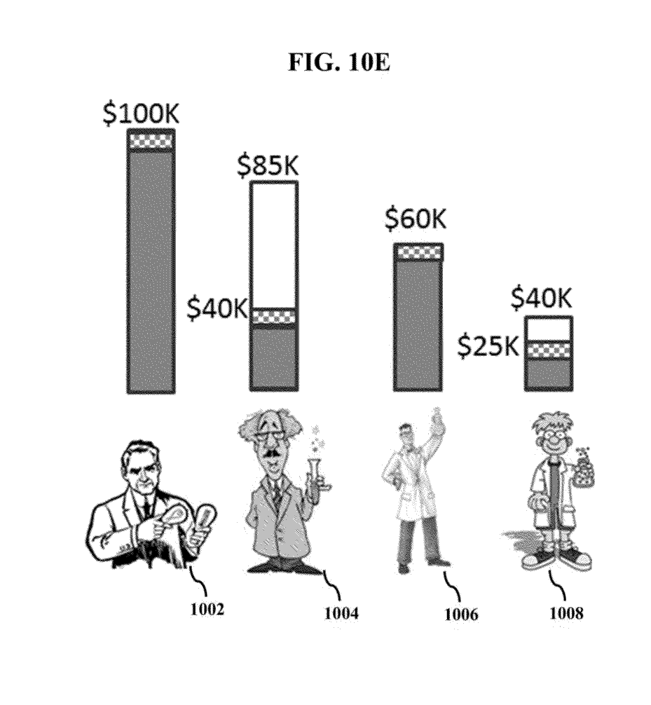

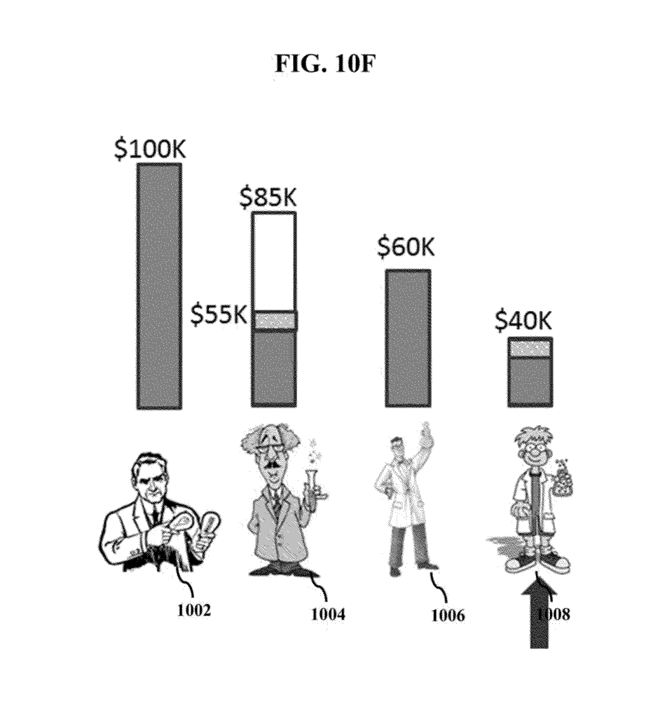

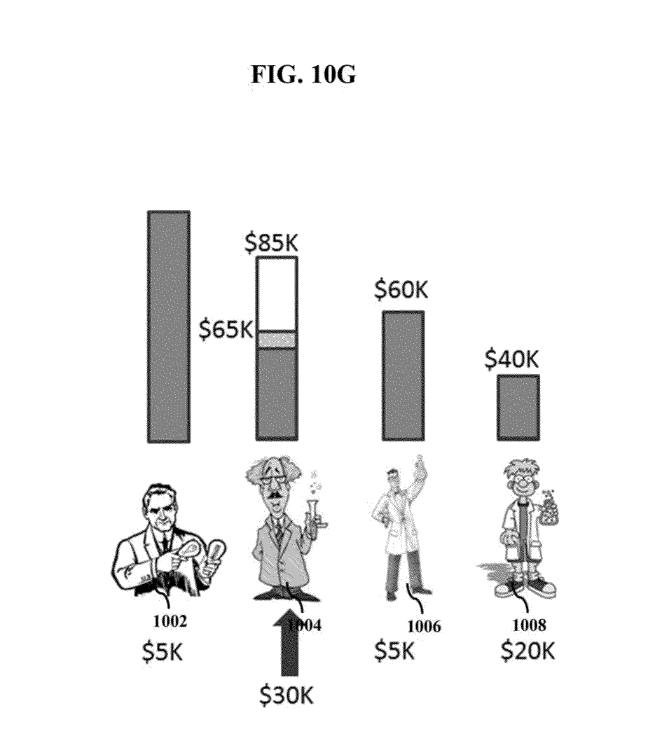

A method of distributing donations in accordance with aspects of the present invention will now be described with additional reference to FIGS. 9-10G.

FIG. 9 illustrates a method 900 of distributing donations in accordance with an aspect of the present invention.

Consider the situation where a potential donor, Bob, is very passionate about helping find a cure for Amyotrophic Lateral Sclerosis (ALS). In fact, Bob's 10 year old daughter has such a death sentence. Suppose Bob finds twelve researchers, all of whom are all at reputable institutions, and all of whom have posted requests through RCDs for example as discussed above, with respect to FIG. 1. Further, suppose Bob is unable to fully understand what any of the researchers are actually doing in their research, let alone decide which researcher's research has the most promising outcome with respect to a cure for ALS.

In accordance with aspects of the present invention, Bob can easily donate his money to all researchers in the group of ALS researchers. In this manner, the researchers will all share in his donation. This group donation will enable many donors give to areas of research as oppose to specific researchers.

This group donation feature is additionally valuable in situations, where donors evaluate a researcher's potential success or contribution to a cure based on the pedigree of the researcher's institution. In short, the more respected institutions are more likely to develop a cure. Right or wrong, some donors prescribe to this logic. What happens though when there are multiple researchers at different, yet equally prestigious, research institutions? The group donations would let Bob donate to multiple researchers in this situation.

As shown in the figure, method 900 starts (S902) and the posting signals are received (S904). For example, an example donation situation in accordance with aspects of the present invention will now be described with reference to FIGS. 10A-G.

As shown in FIG. 10A, suppose that a group of postings, in which a donor would like to donate, includes four researchers: researcher 1002 is asking for $100K and has already received $95K; researcher 1004 is asking for $85K and has already received $35K; researcher 1006 is asking for $60K and has already received $55K; and researcher 1008 is asking for $40K and has already received $20K. For purposes of this discussion, all the posted requests are for nice evenly rounded amounts. This is only to simplify the discussion, wherein in reality each posting, would likely be a more exact amount.

As shown in FIGS. 1-2 a plurality of researchers may post requests for donations. As shown in FIG. 6, each posting request is received by communication component 602 as a posting signal, which is then forwarded to posting communication component 604.

Returning to FIG. 9, after the posting signals have been received (S904), the posting signals are stored (S906). For example, as shown in FIG. 6, the posting signals each have an associated posting value, which is then forwarded to database 610.

As shown in FIG. 7, write controller 702 writes the data associated with each posting in a respective posting register. Included in the data is the associated posting value.

Returning to FIG. 9, after the posting signals have been stored (S906), a distribution signal is received (S908). For example, consider the situation where as donor, Bob, wants to donate $60,000. As shown in FIG. 4, let. Bob send a request to donate $60,000 from DCD 116 as distribution signal 402, wherein the donation is to be distributed between all the posters from the four researchers from FIG. 10A.

As shown in FIG. 6; each donation is received by communication component 602 as a distribution communication, which is then forwarded to distribution communication component 606.

Returning to FIG. 9, after the distribution signal is received (S908), the posting, amounts are accessed (S910). For example, returning to FIG. 6, distributor 608 accesses database 610. As shown in FIG. 7, read/write controller 706 retrieves the current posting values in the posting registers for all the postings associated with the donation. For example, as shown in FIG. 10A, the current posting amount for researcher 1002 is $95,000, with $5000 outstanding from the original $100,000 that was requested. Similarly: the current posting amount for researcher 1004 is $35,000, with $50,000 outstanding from the original $85,000 that was requested; the current posting amount for researcher 1006 is $55,000, with $5,000 outstanding from the original $60,000 that was requested; and the current posting amount for researcher 1008 is $20,000, with $20,000 outstanding from the original $40,000 that was requested.

Returning to FIG. 9, after the posting amounts are accessed (S910), it is determined whether the quotient Q—wherein Q=Dₚ/P_{A}, and wherein the donation D is divided by the number of active posts P_{A} to generate a quotient Q—is greater than the smallest outstanding amount A_{O} (S912). For example, as shown in FIG. 8, comparator 808 may make this determination.

Now, suppose that Bob wants to donate $60K to this group. This is illustrated in FIG. 10B.

If Bob's donation were equally divided between the postings, each poster would receive $15K from Bob's $60K single donation. However, in such a case, as shown in FIG. 10C: researcher 1002 would receive $10K more than the original request; researcher 1004 would receive $15K; researcher 1006 receive $10K more than the original request; and researcher 1008 would receive $15K. This division of the donation is unacceptable because two researchers would receive more than they requested.

To prevent this problem, the donation D is divided by the number of active posts P to generate a quotient Q: Q=Dₚ/P_{A}. If the quotient Q is greater than the smallest outstanding amount A_{O} for an active post, then the smallest outstanding amount A_{O} for the active post is used for all active posts.

Returning to FIG. 9, if Q is less than A_{O} (Yes at S912), the donation is divided and distributed equally (S914).

At this point, method 900 stops (S916).

If Q is not less than A_{O} (No at S912), then the smallest posting request is filled (S914). For example, in the example discussed above, Q ($15K) is greater than A_{O} ($5K). As such, then the smallest outstanding amount. A_{O} for the active post is used for all active posts. Therefore, in this example, $5K is used for all active posts.

Returning to FIG. 9, after the smallest posting request is filled (S914), the remaining distribution is adjusted (S920). For example, as shown in FIG. 10D, the proposed donation D is $60K and the number of active posts P_{A} is 4. So the quotient Q is D/P_{A}, or $60K/4, or $15K. The smallest outstanding amount A_{O} for an active post in this example is $5K for researcher 1006.

This initial equal distribution of a portion of the donation finishes off the request of researcher 1002 and researcher 1006. Researcher 1004 is now at $40K and researcher 1008 is at $25K, as shown in FIG. 10E. The process is then repeated.

Returning to FIG. 9, after the remaining distribution is adjusted (S920), it is again determined whether the quotient. Q is greater than the smallest outstanding amount A_{O} (S912), wherein the method repeats.

The donation D is now modified, as discussed with respect to S920 of FIG. 9, such that it is reduced by the $20K that was equally distributed between the previously active posts. As such D is now $40K. Further, the number of active posts P_{A} is now 2. So the quotient Q is D/P_{A}, or $40K/2, or $20K. The smallest outstanding amount A_{O} for an active post in this example is $15K for researcher 1008.

In this case therefore, Q ($20K) is greater than A_{O} ($15K). As such, then the smallest outstanding, amount A_{O} for the active post is used for all active posts. Therefore, in this example, $15K is used for all active posts, as shown in FIG. 10F.

This equal distribution of a portion of the donation finishes off the request of researcher 1008. Researcher 1004 is now at $55K and the process is again repeated.

At this point, the only active post is that of researcher 1004. Therefore, at this point, researcher 1004 receives the remainder of the donation, which is another $10K, as shown in FIG. 10G. In this respect. Bob's donation to the group of researchers is not equally distributed. However, researcher 1002 received $5K to close out his post, researcher 1004 received $30K, researcher 1006 received $5K to close out his post, and researcher 1008 received $20K to rinse out his post.

In the event that the quotient Q is smaller than the smallest outstanding amount A_{O} for an active post, then the quotient Q is used for all active posts.

In the event that the quotient Q is less than $0.01 (a donor cannot give less than a cent), then the maximum active posts that are closest to closing out will receive the group donation.

As a further note, when a potential donor scrolls over a group of posts, the total outstanding amount for all the posts within the group is provided. In this s r the potential donor will know a hunt of their donation to the group.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A system for use with a first receiving communication device, a second receiving communication device, a first distribution communication device and a second distribution communication device, the first receiving communication device being operable to transmit a first posting signal having a first associated posting value, the second receiving communication device being operable to transmit a second posting signal having a second associated posting value, the first distribution communication device being operable to transmit a first distribution signal having a first distribution associated value, the second distribution communication device being operable to transmit a second distribution signal having a second distribution associated value, said system comprising:
a posting communication component operable receive the first posting signal and the second posting signal;
a first posting register operable to store a first posting amount based on the first associated posting value;
a second posting register operable to store a first posting amount based on the first associated posting value;
a distribution communication component operable to receive the first distribution signal; and
a distributor operable to access said first posting, register, to access said second posting register and to distribute a first distribution amount based on the first distribution signal to said first posting register,
wherein said first posting register is further operable to generate a third posting amount based on the difference between the first posting amount and the first distribution amount,
wherein said distribution communication component is further operable to receive the second distribution signal,
wherein said distributor is further operable to distribute a second distribution amount to said first posting register and to distribute a third distribution amount to said second posting register,
wherein the second distribution amount is based on the second distribution signal and the third posting amount, and
wherein the third distribution amount is based on the second distribution signal and the second distribution amount.
